(19) United States
(12) Patent Application Publication
(10) Pub. No.: US 2023/0086878 A1
(43) Pub. Date: Mar. 23, 2023

(54) WORK SYSTEM AND CONTROL METHOD

(71) Applicant: KOMATSU LTD., Tokyo (JP)

(72) Inventor: Ryuta OKUWAKI, Tokyo (JP)

(21) Appl. No.: 17/802,621

(22) PCT Filed: Apr. 16, 2021
(86) PCT No.: PCT/JP2021/015674

§ 371 Date: Aug. 26, 2022

(30) Foreign Application Priority Data
Apr. 17, 2020 (JP) 2020-074368

(51) Int. Cl. E02F 9/20; E02F 3/43; E02F 9/26; B65G 67/04; G05D 1/02

(52) U.S. Cl. CPC E02F 9/2054; E02F 3/439; E02F 9/205; E02F 9/265; B65G 67/04; G05D 1/0212; G05D 2201/0202

(57) ABSTRACT

A first control unit outputs, to a work machine including work equipment, a first control signal of moving the work equipment to a position above a loading point before a transport vehicle including a dump body reaches the loading point. A transmission unit transmits, to the transport vehicle, an accessing instruction to travel the transport vehicle such that the dump body is located at the loading point. A second control unit outputs a second control signal of controlling the work machine or the transport vehicle such that a deviation between a waiting position of the work equipment and a position of the dump body when the transport vehicle arrives at the loading point based on the accessing instruction becomes small. The waiting position is a position of the work equipment holding an excavation object and waiting based on the first control signal.

### CROSS-REFERENCE TO RELATED APPLICATIONS

This application is a U.S. National stage application of International Application No. PCT/JP2021/015674, filed on Apr. 16, 2021. This U.S. National stage application claims priority under 35 U.S.C. §119(a) to Japanese Patent Application No. 2020-074368, filed in Japan on Apr. 17, 2020, the entire contents of which are hereby incorporated herein by reference.

The present invention relates to a work system and a control method which control a machine operating in a work site.

Priority is claimed to Japanese Patent Application No. 2020-074368, filed Apr. 17, 2020, the content of which is incorporated herein by reference.

### BACKGROUND INFORMATION

Japanese Unexamined Patent Application, First Publication No. 2019-065660 discloses a technique of automatically controlling a process of loading an excavation object, which has been excavated by a work machine, to a transport vehicle in a work site. In the technique disclosed in Japanese Unexamined Patent Application, First Publication No. 2019-065660, based on an accessing signal to a loading point specified by the work machine, the transport vehicle moves to the loading point, and after the moving of the transport vehicle to the loading point is completed, the work machine dumps the excavation object. Accordingly, the transport vehicle moves to the loading point by automatic control, and the work machine performs loading of the excavation object by automatic control.

### SUMMARY

In order to control the loading effectively, the work machine may cause work equipment holding the excavation object to move to the loading point before the transport vehicle reaches the loading point, so that the work machine can quickly dump the excavation object when the transport vehicle reaches the loading point. However, it is difficult for the transport vehicle to stop at the loading point without error. There is a possibility that, in a case where the transport vehicle stops at a position deviated from the loading point, the excavation object may spill from a dump body of the transport vehicle when the excavation object held by the work machine is dumped.

In view of the problem described above, an object of the present disclosure is to provide a work system and a control method which can prevent an excavation object held by a work machine from spilling when the excavation object is dumped in a transport vehicle.

According to a first aspect of the present invention, a work system controls a machine operating in a work site, and includes: a first control unit configured to output, to a work machine including work equipment, a first control signal of moving the work equipment to a position above a loading point before a transport vehicle including a dump body reaches the loading point; a transmission unit configured to transmit, to the transport vehicle, an accessing instruction to travel the transport vehicle such that the dump body is located at the loading point; and a second control unit configured to output a second control signal of controlling the work machine or the transport vehicle such that a deviation between a waiting position of the work equipment and a position of the dump body when the transport vehicle arrives at the loading point based on the accessing instruction becomes small, the waiting position being a position of the work equipment holding an excavation object and waiting based on the first control signal.

According to the aspect, it is possible to prevent an excavation object held by a work machine from spilling when the excavation object is dumped in a transport vehicle.

### BRIEF DESCRIPTION OF THE DRAWINGS

FIG. 1 is a schematic view illustrating a configuration of a work system according to a first embodiment.

FIG. 2 is an external view of a work machine according to the first embodiment.

FIG. 3 is a block diagram showing a configuration of a controlling gear according to the first embodiment.

FIG. 4 is a diagram showing an example of a travel route.

FIG. 5 is a top view showing an example of the positional relationship between a bucket and a dump body.

FIG. 6 shows a relationship between a deviation angle and a swing command value in a deviation adjustment control of the first embodiment.

FIG. 7 is a sequence view illustrating a loading control by the work system according to the first embodiment.

FIG. 8 is a sequence view illustrating the loading control by the work system according to the first embodiment.

### DETAILED DESCRIPTION OF EMBODIMENTS

### First Embodiment

### Work System 1

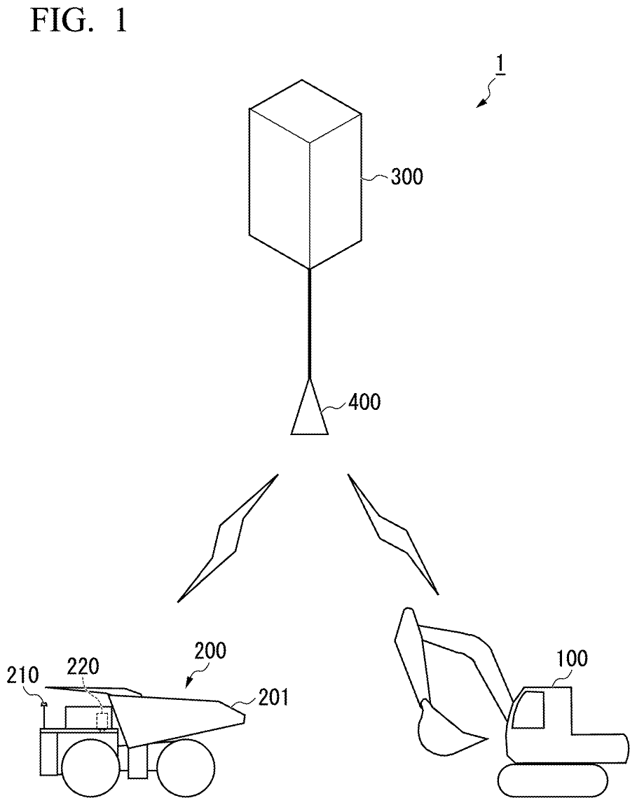

FIG. 1 is a schematic view illustrating a configuration of a work system according to a first embodiment.

A work system 1 incudes a work machine 100, one or a plurality of transport vehicles 200, and a controlling gear 300. The work system 1 is an unmanned transfer system that automatically controls the work machine 100 and the transport vehicle 200 by the controlling gear 300. The controlling gear 300 is an example of a work system.

The transport vehicle 200 travels in an unmanned manner based on course data (for example, speed data and coordinates for which the transport vehicle 200 is to head) received from the controlling gear 300. The transport vehicle 200 and the controlling gear 300 are connected to each other through communication via an access point 400. The controlling gear 300 acquires a position and an azimuth direction from the transport vehicle 200 and generates course data used in the traveling of the transport vehicle 200 based on the position and the azimuth direction. The controlling gear 300 transmits the course data to the transport vehicle 200. The transport vehicle 200 travels in an unmanned manner based on the received course data. The work system 1 according to the first embodiment includes the unmanned transfer system, but some or all of the transport vehicles 200 may be operated in a manned manner in another embodiment. In this case, the controlling gear 300 does not need to perform transmission of the course data and an instruction related to loading, but the controlling gear 300 acquires the position and azimuth direction of the transport vehicle 200.

The work machine 100 is controlled in an unmanned manner according to instructions received from the controlling gear 300. The work machine 100 and the controlling gear 300 are connected to each other through communication via the access point 400.

The work machine 100 and the transport vehicle 200 are provided at a work site (for example, a mine or a quarry). The controlling gear 300 may be provided at an arbitrary site. For example, the controlling gear 300 may be provided at a point (for example, a city or an inside of the work site) separated away from the work machine 100 and the transport vehicle 200.

### Transport Vehicle 200

The transport vehicle 200 according to the first embodiment is a dump truck including a dump body 201. The transport vehicle 200 according to another embodiment may be a transport vehicle other than a dump truck.

The transport vehicle 200 includes the dump body 201, a position and azimuth direction calculator 210, and a control device 220. The position and azimuth direction calculator 210 calculates a position of the transport vehicle 200 and an azimuth direction of the transport vehicle 200. The position and azimuth direction calculator 210 includes two receivers that receive positioning signals from an artificial satellite that configures Global Navigation Satellite System (GNSS). An example of GNSS is the Global Positioning System (GPS). The two receivers are provided at positions different from each other on the transport vehicle 200. The position and azimuth direction calculator 210 detects the position of the transport vehicle 200 in a site coordinate system based on the positioning signal received by the receiver. The position and azimuth direction calculator 210 uses the respective positioning signals received by the two receivers to calculate an azimuth direction in which the transport vehicle 200 faces as a relationship between a provision position of one receiver and a provision position of the other receiver. Without being limited thereto, in another embodiment, for example, the transport vehicle 200 may include an inertial measurement unit (IMU), and an azimuth direction may be calculated based on the measurement result from the inertial measurement device. In this case, the drift of the inertial measurement unit may be corrected based on a traveling trajectory of the transport vehicle 200.

The control device 220 transmits, to the controlling gear 300, the detected position and the calculated azimuth direction by the position and azimuth direction calculator 210. The control device 220 receives, from the controlling gear 300, course data, a dumping instruction, an accessing instruction to a loading point P3, and a departure instruction from the loading point P3. The control device 220 causes the transport vehicle 200 to travel according to the received course data, or moves the dump body 201 of the transport vehicle 200 up and down according to the dumping instruction. When the transport vehicle arrives at the destination and stops based on the instructions, the control device 220 transmits an arrival notification indicating the arrival at the destination to the controlling gear 300.

### Work Machine 100

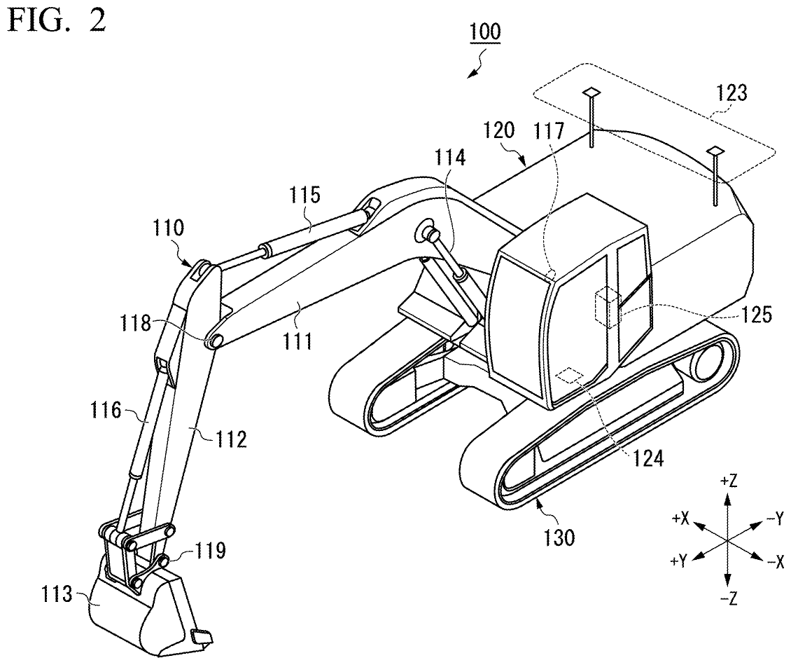

FIG. 2 is an external view of the work machine 100 according to the first embodiment.

The work machine 100 according to the first embodiment is a hydraulic excavator. The work machine 100 according to another embodiment may be a work vehicle other than the hydraulic excavator.

The work machine 100 includes work equipment 110 that is operated by a hydraulic pressure, a swing body 120 that supports the work equipment 110, and a travel body 130 that supports the swing body 120.

The work equipment 110 includes a boom 111, an arm 112, a bucket 113, a boom cylinder 114, an arm cylinder 115, a bucket cylinder 116, a boom angle sensor 117, an arm angle sensor 118, and a bucket angle sensor 119.

A base end portion of the boom 111 is attached to a front portion of the swing body 120 via a pin.

The arm 112 connects the boom 111 to the bucket 113. A base end portion of the arm 112 is attached to a tip portion of the boom 111 via a pin.

The bucket 113 includes an edge for excavating an excavation object such as earth and a container for conveying the excavation object. A base end portion of the bucket 113 is attached to a tip portion of the arm 112 via a pin. Examples of the excavation object include earth, ore, crushed stone, coal, and the like.

The boom cylinder 114 is a hydraulic cylinder for operating the boom 111. A base end portion of the boom cylinder 114 is attached to the swing body 120. A tip portion of the boom cylinder 114 is attached to the boom 111.

The arm cylinder 115 is a hydraulic cylinder for driving the arm 112. A base end portion of the arm cylinder 115 is attached to the boom 111. A tip portion of the arm cylinder 115 is attached to the arm 112.

The bucket cylinder 116 is a hydraulic cylinder for driving the bucket 113. A base end portion of the bucket cylinder 116 is attached to the arm 112. A tip portion of the bucket cylinder 116 is attached to the bucket 113.

The boom angle sensor 117 is attached to the boom 111 and detects an inclination angle of the boom 111.

The arm angle sensor 118 is attached to the arm 112 and detects an inclination angle of the arm 112.

The bucket angle sensor 119 is attached to the bucket 113 and detects an inclination angle of the bucket 113.

The boom angle sensor 117, the arm angle sensor 118, and the bucket angle sensor 119 according to the first embodiment each detect an inclination angle with respect to a horizontal plane. An angle sensor according to another embodiment is not limited thereto and may detect an inclination angle with respect to another reference plane. For example, in another embodiment, an angle sensor may detect a relative angle with respect to a mounting part or may detect an inclination angle by measuring the stroke of each cylinder and converting the stroke into an angle.

The work machine 100 includes a position and azimuth direction calculator 123, an inclination measuring instrument 124, and a control device 125.

The position and azimuth direction calculator 123 calculates a position of the swing body 120 and an azimuth direction in which the swing body 120 faces. The position and azimuth direction calculator 123 includes two receivers that receive positioning signals from an artificial satellite that configures GNSS. The two receivers are provided at positions different from each other on the swing body 120. The position and azimuth direction calculator 123 detects a position of a representative point of the swing body 120 (for example, a swing center of the swing body 120) in the site coordinate system based on the positioning signal received by one receiver. The control device 125 can convert a position in the site coordinate system to a position in a machine coordinate system and vice versa by using the position of the representative point of the swing body 120 in the site coordinate system. The machine coordinate system is an orthogonal coordinate system with the representative point of the swing body 120 as a reference.

The position and azimuth direction calculator 123 uses the respective positioning signals received by the two receivers to calculate an azimuth direction in which the swing body 120 faces as a relationship between a provision position of one receiver and a provision position of the other receiver.

The inclination measuring instrument 124 measures the acceleration and angular velocity of the swing body 120 and detects a posture (for example, a roll angle, a pitch angle, or a yaw angle) of the swing body 120 based on the measurement result. The inclination measuring instrument 124 is provided, for example, on a lower surface of the swing body 120. The inclination measuring instrument 124 can use, for example, an inertial measurement unit (IMU).

The control device 125 transmits, to the controlling gear 300, the swinging speed, the position, and the azimuth direction of the swing body 120, the inclination angles of the boom 111, the arm 112, and the bucket 113, the traveling speed of the travel body 130, and the posture of the swing body 120. Hereinafter, data collected by the work machine 100 or the transport vehicle 200 from various sensors is also referred to as vehicle data. Vehicle data according to another embodiment is not limited to this. For example, vehicle data according to another embodiment may not include the swinging speed, the position, the azimuth direction, the inclination angle, the traveling speed or the posture, may include a value detected by another sensor, or may include a value calculated from the detected value.

The control device 125 receives a control instruction from the controlling gear 300. The control device 125 drives the work equipment 110, the swing body 120, or the travel body 130 in accordance with the received control instruction. When the drive based on the control instruction is completed, the control device 125 transmits a completion notification to the controlling gear 300.

### Controlling Gear 300

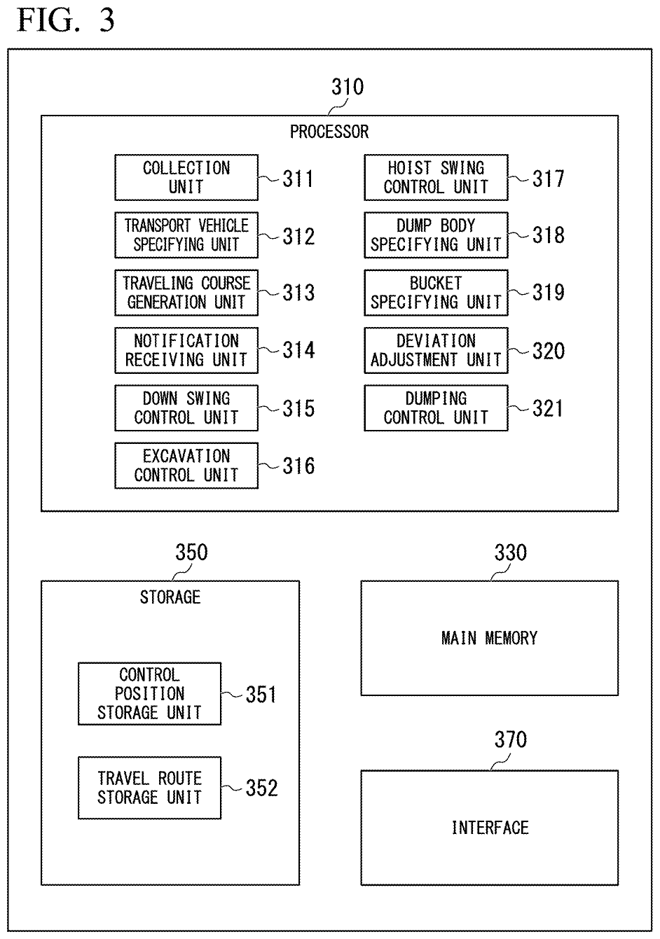

FIG. 3 is a block diagram showing a configuration of the controlling gear according to the first embodiment.

The controlling gear 300 manages the operation of the work machine 100 and the traveling of the transport vehicle 200.

The controlling gear 300 is a computer including a processor 310, a main memory 330, a storage 350, and an interface 370. The storage 350 stores a program. The processor 310 reads the program from the storage 350 to load the program in the main memory 330 and executes processing in accordance with the program. The controlling gear 300 is connected to a network via the interface 370. Examples of the processor 310 include a Central Processing Unit (CPU), a Graphic Processing Unit (GPU), and a microprocessor.

The program may realize some of functions to be exhibited by the computer of the controlling gear 300. For example, the program may exhibit functions in combination with another program that is already stored in the storage or in combination with another program installed in another device. In another embodiment, the controlling gear 300 may include a custom large scale integrated circuit (LSI), such as a programmable logic device (PLD), in addition to the above configuration or instead of the above configuration. Examples of the PLD include a programmable array logic (PAL), a generic array logic (GAL), a complex programmable logic device (CPLD), and a field programmable gate array (FPGA). In this case, some or all of the functions to be realized by the processor 310 may be realized by the integrated circuit. Such an integrated circuit is also included as an example of the processor.

The storage 350 has storage areas as a control position storage unit 351 and a travel route storage unit 352. Examples of the storage 350 include a magnetic disk, a magneto-optical disk, an optical disk, and a semiconductor memory. The storage 350 may be an internal medium directly connected to a common communication line of the controlling gear 300 or may be an external medium connected to the controlling gear 300 via the interface 370. The storage 350 is a non-transitory tangible storage medium.

The control position storage unit 351 stores position data of an excavation point and the loading point P3. For example, the excavation point and the loading point P3 are set in advance by a manager or the like of the work site. The position data of the excavation point and the loading point P3, which are stored in the control position storage unit 351, may be updated by the manager or the like based on the progress of the work.

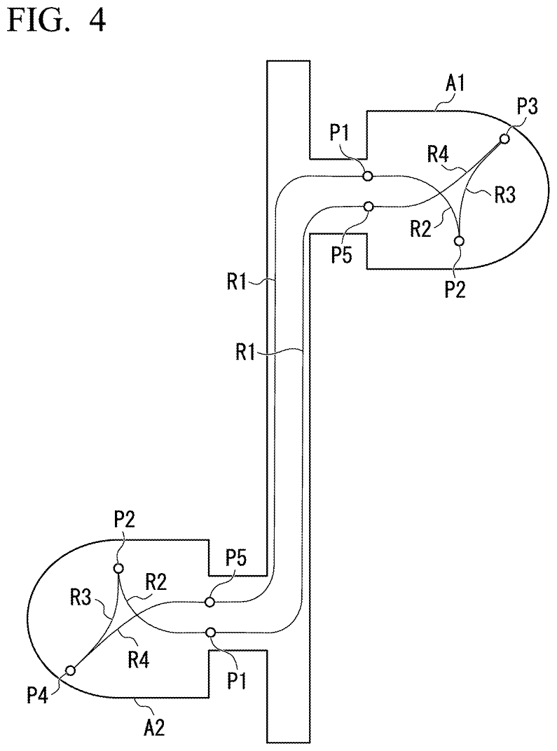

FIG. 4 is a diagram showing an example of a travel route.

The travel route storage unit 352 stores a travel route R for each transport vehicle 200. The travel route R has a connection route R1 which connects two areas A (for example, a loading site A1 and a dumping site A2) to each other and is determined in advance, and an access route R2, an approach route R3, and an exit route R4 which are routes in the area A. The access route R2 is a route that connects a standby point P1, which is one end of the connection route R1, and a predetermined turning point P2 to each other in the area A. The approach route R3 is a route that connects the turning point P2 and the loading point P3 or a dumping point P4 to each other in the area A. The exit route R4 is a route that connects the loading point P3 or the dumping point P4 and an exit point P5, which is the other end of the connection route R1, to each other in the area A. The turning point P2 is a point set by the controlling gear 300 according to the position of the loading point P3. The controlling gear 300 calculates the access route R2, the approach route R3, and the exit route R4 each time the loading point P3 is changed.

By executing the program, the processor 310 includes a collection unit 311, a transport vehicle specifying unit 312, a traveling course generation unit 313, a notification receiving unit 314, a down swing control unit 315, an excavation control unit 316, a hoist swing control unit 317, a dump body specifying unit 318, a bucket specifying unit 319, a deviation adjustment unit 320, and a dumping control unit 321.

The collection unit 311 receives the vehicle data from the work machine 100 and the transport vehicle 200 via the access point 400.

The transport vehicle specifying unit 312 specifies the transport vehicle 200 as a target vehicle on which the excavation object is to be loaded based on the vehicle data of the transport vehicle 200 collected by the collection unit 311.

The traveling course generation unit 313 generates course data indicating an area where the movement of the transport vehicle 200 is allowed based on the travel route stored in the travel route storage unit 352 and the vehicle data collected by the collection unit 311 and transmits the course data to the transport vehicle 200. The course data is, for example, data indicating an area where the transport vehicle 200 can travel at a predetermined speed within a certain period of time and which does not overlap a travel route of another transport vehicle 200.

The notification receiving unit 314 receives the completion notification from the work machine 100 and receives the arrival notification from the transport vehicle 200.

The down swing control unit 315 transmits a down swing instruction, which includes the position of the excavation point stored in the control position storage unit 351, to the work machine 100. When receiving the down swing instruction, the control device 125 of the work machine 100 drives the swing body 120 and the work equipment 110 so as to move the bucket 113 to a position directly above the excavation point, based on the vehicle data of the work machine 100.

The excavation control unit 316 transmits an excavation instruction to the work machine 100. When receiving the excavation instruction, the control device 125 of the work machine 100 rotates the arm 112 in a pulling direction and rotates the bucket 113 in an excavation direction to excavate the excavation object. In a case where the work machine 100 is a face excavator, the excavation control unit 316 rotates the arm 112 in a pushing direction.

The hoist swing control unit 317 transmits a hoist swing instruction, which includes the position of the loading point P3 stored in the control position storage unit 351, to the work machine 100. When receiving the hoist swing instruction, the control device 125 of the work machine 100 drives the swing body 120 and the work equipment 110 so as to move the bucket 113 to a position directly above the loading point P3 based on the vehicle data of the work machine 100.

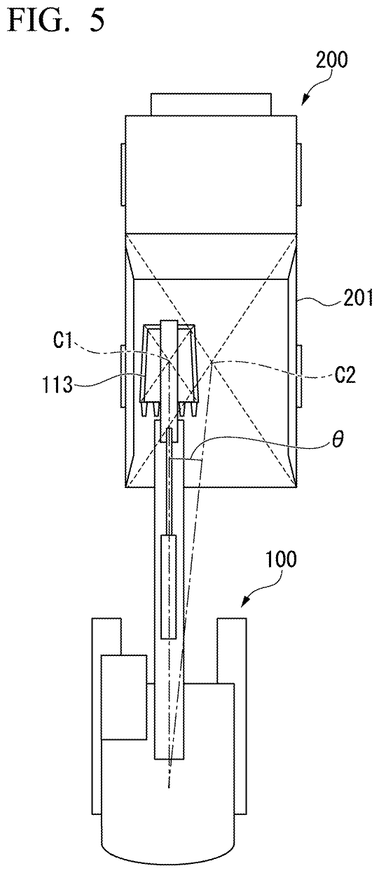

FIG. 5 is a top view showing an example of the positional relationship between the bucket 113 and the dump body 201.

When receiving the arrival notification at the loading point P3 from the transport vehicle 200, the dump body specifying unit 318 specifies a center position of the dump body 201 of the transport vehicle 200 based on the vehicle data of the transport vehicle 200 collected by the collection unit 311. When the distance between a reference position of the transport vehicle 200 (a position of the transport vehicle 200 that serves as a reference for the position data) and the center position of the dump body 201 are known, a position moved from the position indicated by the position data, by the above known distance, in a direction indicated by the azimuth data can be specified as the center position C2 of the dump body 201. For example, as shown in FIG. 5, the center position C2 of the dump body 201 may be the geometric center of gravity of the contour of the dump body 201 when the dump body 201 is viewed from above in a plan view.

The bucket specifying unit 319 specifies a center position C1 of the bucket 113 based on the vehicle data of the work machine 100 collected by the collection unit 311. For example, as shown in FIG. 5, the center position C1 of the bucket 113 may be the geometric center of gravity of the contour of the bucket 113 when the bucket 113 is viewed from above in a plan view.

The deviation adjustment unit 320 transmits a deviation adjustment instruction including the center position C2 of the dump body 201 such that the deviation between the center position C1 of the bucket 113 and the center position C2 of the dump body 201 becomes small. The deviation adjustment instruction is not limited to the center position, and the deviation adjustment instruction according to another embodiment may be an instruction that a distance between predetermined points of the bucket 113 and the dump body 201 becomes small, or that an angle formed by predetermined planes of the bucket 113 and the dump body 201 becomes small. The deviation according to the first embodiment is represented by a deviation angle θ formed by a line connecting the swing center of the swing body 120 and the center position of the bucket 113 and a line connecting the swing center of the swing body 120 and the center position of the dump body 201. In other words, the deviation according to the first embodiment is a deviation in a left-right direction with respect to the work machine 100.

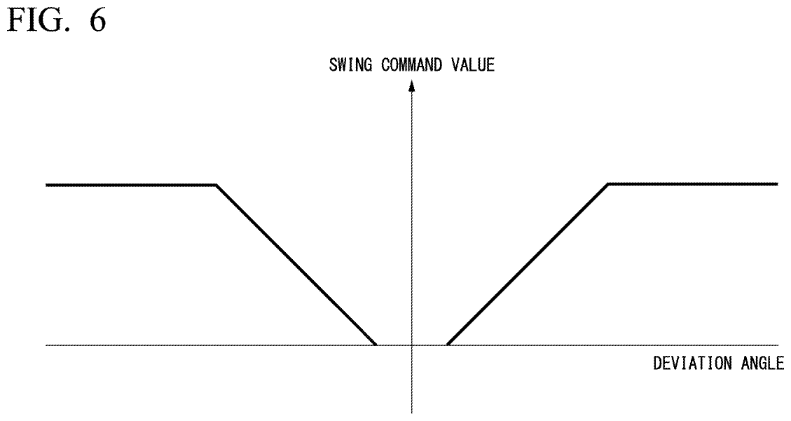

When receiving the deviation adjustment instruction, the control device 125 of the work machine 100 converts, based on the vehicle data of the work machine 100, the center position C2 of the dump body 201 into a position in the machine coordinate system with the swing body 120 as a reference. That is, the control device 125 converts the center position C2 of the dump body 201 represented in the site coordinate system into a position in the machine coordinate system with the swing body 120 as a reference, by rotating and moving in parallel the center position C2 of the dump body 201 based on the position, the azimuth direction, and the inclination of the swing body 120 of the work machine 100. The control device 125 drives the swing body 120 until the deviation angle θ falls within a predetermined adjustment end range (for example, ±1 degree). FIG. 6 shows a relationship between the deviation angle and a swing command value in the deviation adjustment control of the first embodiment. In the deviation adjustment control by the control device 125, the swing command value monotonically increase with respect to the absolute value of the deviation angle θ. In other words, the larger the deviation angle θ, the faster the swing angular velocity. When the absolute value of the deviation angle θ exceeds a predetermined threshold value, the swing command value becomes constant at the maximum value. When the deviation angle θ is within the adjustment end range, the swing command value is zero.

In another embodiment, the control device 125 may drive the boom 111 or the arm 112, based on the vehicle data of the work machine 100, until a difference between the length of a line segment connecting the swing center of the swing body 120 and the center position C1 of the bucket 113 and the length of a line segment connecting the swing center of the swing body 120 and the center position C2 of the dump body 201 falls within a predetermined length range. In other words, in another embodiment, the control device 125 may control the work machine 100 such that the deviation in a front-rear direction with respect to the work machine 100 becomes small.

The dumping control unit 321 transmits a dumping instruction to the work machine 100. When receiving the dumping instruction, the control device 125 of the work machine 100 rotates the bucket 113 in a dump direction to dump the excavation object.

### Control Method

A loading control by the work system 1 according to the first embodiment will be described.

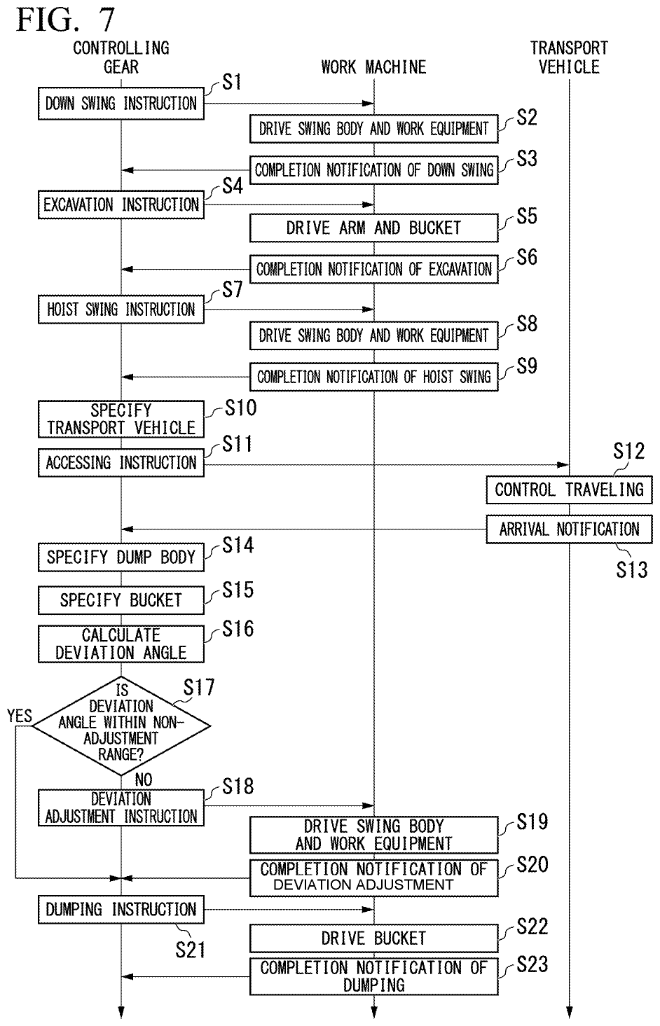

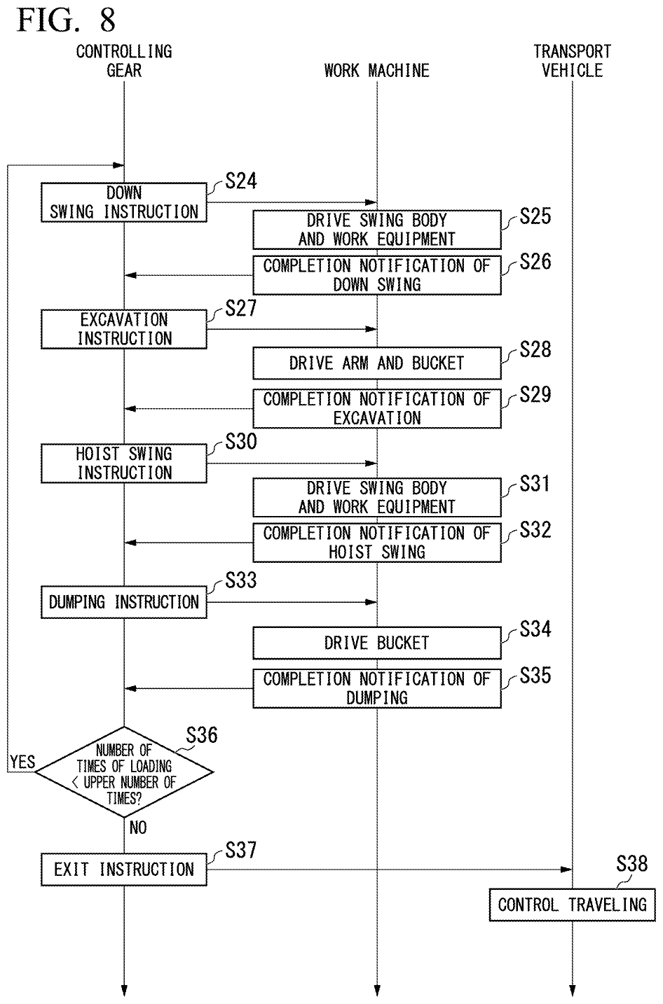

FIGS. 7 and 8 are sequence views illustrating a loading control by the work system 1 according to the first embodiment. The collection unit 311 of the controlling gear 300 receives the vehicle data from the work machine 100 and the transport vehicle 200 at regular intervals during the following loading control.

The down swing control unit 315 of the controlling gear 300 reads the position data of the excavation point from the control position storage unit 351 and transmits a down swing instruction including the position data of the excavation point to the work machine 100 (step S1). When receiving the down swing instruction, the control device 125 of the work machine 100 drives the swing body 120 and the work equipment 110 so as to move the center position C1 of the bucket 113 to a position directly above the excavation point, for example based on the vehicle data (step S2). When the distance between the center position C1 of the bucket 113 and the excavation point is within a predetermined distance by driving, the control device 125 stops the driving of the swing body 120 and the work equipment 110 and transmits a completion notification of the down swing to the controlling gear 300 (step S3).

The notification receiving unit 314 of the controlling gear 300 receives the completion notification of the down swing from the work machine 100. When receiving the completion notification of the down swing, the excavation control unit 316 transmits an excavation instruction to the work machine 100 (step S4). When receiving the excavation instruction, the control device 125 of the work machine 100 rotates the arm 112 in the pulling direction and rotates the bucket 113 in the excavation direction to excavate the excavation object (step S5). When the angle of the bucket 113 becomes equal to or larger than a predetermined excavation angle, the control device 125 stops the driving of the work equipment 110 and transmits a completion notification of the excavation to the controlling gear 300 (step S6).

The notification receiving unit 314 of the controlling gear 300 receives the completion notification of the excavation from the work machine 100. When receiving the completion notification of the excavation, the hoist swing control unit 317 reads the position data of the loading point P3 from the control position storage unit 351 and transmits a hoist swing instruction including the position data of the loading point P3 to the work machine 100 (step S7). In other words, the hoist swing control unit 317 is an example of a first control unit that outputs a first control signal of moving the work equipment 110 of the work machine 100 to the loading point P3 before the transport vehicle 200 reaches the loading point P3.

When receiving the hoist swing instruction, the control device 125 of the work machine 100 drives the swing body 120 and the work equipment 110 so as to move the center position C1 of the bucket 113 to a position directly above the loading point P3 based on the vehicle data of the work machine 100 (step S8). When the distance between the center position C1 of the bucket 113 and the loading point P3 is within a predetermined distance by driving, the control device 125 stops the driving of the swing body 120 and the work equipment 110 and transmits a completion notification of the hoist swing to the controlling gear 300 (step S9).

The notification receiving unit 314 of the controlling gear 300 receives the completion notification of the hoist swing from the work machine 100. The transport vehicle specifying unit 312 specifies, for example, the transport vehicle 200 located at the turning point P2 based on the vehicle data of the transport vehicle 200 collected by the collection unit 311 (step S10). The traveling course generation unit 313 generates course data based on the vehicle data of the specified transport vehicle 200 and transmits the course data to the transport vehicle 200 (step S11). In other words, the traveling course generation unit 313 is an example of a transmission unit that transmits, to the transport vehicle 200, an accessing instruction to move the transport vehicle 200 such that the dump body 201 is located at the loading point P3.

When receiving the course data, the control device 220 of the transport vehicle 200 controls the traveling of the transport vehicle 200 toward the loading point P3 according to the course data (step S12). When the distance between a predetermined position of the dump body 201 and the loading point P3 is within a predetermined distance, the control device 220 stops the traveling of the transport vehicle 200 and transmits an arrival notification at the loading point P3 to the controlling gear 300 (step S13). Note that the center position C2 of the dump body 201 of the transport vehicle 200 and the loading point P3 do not always match when the transport vehicle 200 is stopped.

The notification receiving unit 314 of the controlling gear 300 receives the arrival notification at the loading point P3 from the transport vehicle 200. When receiving the arrival notification at the loading point P3, the dump body specifying unit 318 of the controlling gear 300 specifies the center position C2 of the dump body 201 based on the vehicle data of the transport vehicle 200 (step S14). The dump body specifying unit 318 converts the center position C2 of the dump body 201 into a position in the machine coordinate system with the swing body 120 as a reference, based on the position of the representative point of the swing body 120 in the site coordinate system.

The bucket specifying unit 319 specifies the center position C1 of the bucket 113 based on the vehicle data of the work machine 100 (step S15). In other words, the bucket specifying unit 319 specifies a waiting position of the bucket 113 which is a position of the bucket 113 in a state of holding the excavation object and waiting based on the hoist swing instruction in step S7.

The deviation adjustment unit 320 calculates a deviation angle between the center position C2 of the dump body 201 specified in step S14 and the center position C1 of the bucket 113 specified in step S15 (step S16). The deviation adjustment unit 320 determines whether or not the calculated deviation angle is within a predetermined non-adjustment range (for example, ±2 degrees) (step S17). When the deviation angle exceeds the non-adjustment range (step S17: NO), the deviation adjustment unit 320 transmits a deviation adjustment instruction including the center position C2 of the dump body 201 in the site coordinate system specified in step S14 (step S18). In the first embodiment, the controlling gear 300 moves the bucket 113 holding the excavation object to the loading point P3 from step S4 to step S9, and then the transport vehicle 200 is moved to the loading point P3 from step S11 to step S13. Therefore, the deviation adjustment by the deviation adjustment unit 320 is a process of matching the positions of the bucket 113 and the dump body 201 in a case where there is a deviation between the stop position of the transport vehicle 200 and the loading point P3 when the work machine 100 holds the excavation object and waits.

In other words, the deviation adjustment unit 320 is an example of a second control unit that outputs a second control signal of controlling the work machine 100 such that the difference between the position of the work equipment 110 and the position of the dump body 201 becomes small without traveling the transport vehicle 200, when the work equipment 110 holds the excavation object and the arrival notification is received.

When receiving the deviation adjustment instruction, the control device 125 of the work machine 100 converts the center position C2 of the dump body 201 into a position in the machine coordinate system based on the vehicle data. Then, the control device 125 calculates a deviation angle, and drives the swing body 120 according to the swing command value based on FIG. 6 until the deviation angle falls within the adjustment end range (for example, ±1 degree) (step S19). When the deviation angle falls within the adjustment end range, the control device 125 stops the driving of the swing body 120 and transmits a completion notification of the deviation adjustment to the controlling gear 300 (step S20).

When the deviation angle is within the non-adjustment range in step S17 (step S17: YES), or when the notification receiving unit 314 receives the completion notification of the deviation adjustment in step S20, the dumping control unit 321 transmits a dumping instruction to the work machine 100 (step S21). When receiving the dumping instruction, the control device 125 of the work machine 100 rotates the bucket 113 in the dump direction to dump the excavation object (step S22). In the above-described way, the work machine 100 can load the held excavation object into the dump body 201 without spilling the excavation object. When the angle of the bucket 113 becomes equal to or larger than a predetermined dump angle, the control device 125 stops the driving of the work equipment 110 and transmits a completion notification of the dumping to the controlling gear 300 (step S23).

The notification receiving unit 314 of the controlling gear 300 receives the completion notification of the dumping from the work machine 100.

The down swing control unit 315 of the controlling gear 300 reads the position data of the excavation point from the control position storage unit 351 and transmits the down swing instruction including the position data of the excavation point to the work machine 100 (step S24). When receiving the down swing instruction, the control device 125 of the work machine 100 drives the swing body 120 and the work equipment 110 so as to move the center position C1 of the bucket 113 to a position directly above the excavation point, for example based on the vehicle data (step S25). When the distance between the center position C1 of the bucket 113 and the excavation point is within a predetermined distance by driving, the control device 125 stops the driving of the swing body 120 and the work equipment 110 and transmits the completion notification of the down swing to the controlling gear 300 (step S26).

The notification receiving unit 314 of the controlling gear 300 receives the completion notification of the down swing from the work machine 100. When receiving the completion notification of the down swing, the excavation control unit 316 transmits the excavation instruction to the work machine 100 (step S27). When receiving the excavation instruction, the control device 125 of the work machine 100 rotates the bucket 113 in the excavation direction to excavate the excavation object (step S28). When the angle of the bucket 113 becomes equal to or larger than a predetermined excavation angle, the control device 125 stops the driving of the work equipment 110 and transmits the completion notification of the excavation to the controlling gear 300 (step S29).

The notification receiving unit 314 of the controlling gear 300 receives the completion notification of the excavation from the work machine 100. When receiving the completion notification of the excavation, the hoist swing control unit 317 transmits the hoist swing instruction including the center position C2 of the dump body 201 specified in step S14 to the work machine 100 (step S30). When receiving the hoist swing instruction, the control device 125 of the work machine 100 drives the swing body 120 and the work equipment 110 so as to move the center position C1 of the bucket 113 to a position directly above the dump body 201 based on the vehicle data of the work machine 100 (step S31). When the distance between the center position C1 of the bucket 113 and the center position C2 of the dump body 201 is within a predetermined distance by driving, the control device 125 stops the driving of the swing body 120 and the work equipment 110 and transmits the completion notification of the hoist swing to the controlling gear 300 (step S32). That is, in the second and subsequent loadings, the deviation adjustment by the deviation adjustment unit 320 is not performed. In the first loading, after the work machine 100 causes the bucket 113 to hoist swing to a position directly above the loading point P3, the transport vehicle 200 travels to the loading point P3. Therefore, there is a possibility that the dump body 201 of the transport vehicle 200 may deviate from the loading point P3, and it is necessary to perform the deviation adjustment process. On the other hand, in the second and subsequent loadings, the work machine 100 causes the bucket 113 to hoist swing to a position directly above the stopped dump body 201. Therefore, at the time of the second and subsequent loading, the bucket 113 can be moved to a position directly above the dump body 201 without performing the deviation adjustment process.

The notification receiving unit 314 of the controlling gear 300 receives the completion notification of the hoist swing from the work machine 100. When receiving the completion notification of the hoist swing, the dumping control unit 321 transmits the dumping instruction to the work machine 100 (step S33). When receiving the dumping instruction, the control device 125 of the work machine 100 rotates the bucket 113 in the dump direction to dump the excavation object (step S34). At this time, the controlling gear 300 adds 1 to the number of times of loading of the excavation object stored in the memory. When the angle of the bucket 113 becomes equal to or larger than a predetermined dump angle, the control device 125 stops the driving of the work equipment 110 and transmits the completion notification of the dumping to the controlling gear 300 (step S35).

The notification receiving unit 314 of the controlling gear 300 receives the completion notification of the dumping from the work machine 100.

The controlling gear 300 determines whether or not the number of times of loading of the excavation object is less than an upper number of times (step S36). The upper number of times of loading of the excavation object is preset based on the capacity of the bucket 113 and the capacity of the dump body 201. When the number of times of loading of the excavation object is less than the upper number of times (step S36: YES), the process is returned to step S24, and the excavation and loading of earth is performed again.

When the number of times of loading of the excavation object is equal to or more than the upper number of times (step S36: NO), the traveling course generation unit 313 generates course data based on the vehicle data of the transport vehicle 200 specified in step S10 and transmits the course data to the transport vehicle 200 (step S37). In other words, the traveling course generation unit 313 transmits, to the transport vehicle 200, an exit instruction from the loading point P3. When receiving the course data, the control device 220 of the transport vehicle 200 controls the traveling of the transport vehicle 200 according to the course data (step S38). In the above-described way, the transport vehicle 200 into which the excavation object is loaded can exit. The controlling gear 300 resets the number of times of loading of the excavation object stored in the memory.

### Operation and Effects

As described above, according to the first embodiment, the controlling gear 300 outputs the hoist swing instruction to the work machine 100 before the transport vehicle 200 reaches the loading point P3, and transmits course data, which is an accessing instruction to move the transport vehicle 200 such that the dump body 201 is located at the loading point P3, to the transport vehicle 200. The controlling gear 300 receives an arrival notification indicating the completion of arrival at the loading point P3 from the transport vehicle 200, and outputs a deviation adjustment instruction to control the work machine 100 such that the difference between the position of the work equipment 110 and the position of the dump body 201 becomes small without traveling the transport vehicle 200. Accordingly, the controlling gear 300 can prevent the excavation object from spilling when the excavation object held by the work machine 100 is dumped in the transport vehicle 200.

In addition, as a method of reducing the difference between the position of the work equipment 110 and the position of the dump body 201, a method of controlling the traveling of the transport vehicle 200 is considered in which the transport vehicle 200 stops at the loading point P3 without error. However, since the transport vehicle 200 generally travels on tires, it is necessary to repeat forward and backward moving precisely while changing the traveling direction in order to precisely control the stop position of the transport vehicle 200, and it takes time to adjust the deviation.

Therefore, as in the first embodiment, by performing the deviation adjustment by swinging the work machine 100, the time required for the deviation adjustment can be reduced and the productivity can be improved.

### Other Embodiments

The embodiments have been described above in detail with reference to the drawings; however, the specific configurations are not limited to the above-described configurations, and various design changes and the like can be made. In another embodiment, the order of the above-described processes may be appropriately changed. In addition, some of the processes may be executed in parallel. For example, in the above-described embodiment, in the first loading, the accessing instruction is transmitted to the transport vehicle 200 after the hoist swing of the work machine 100 is completed, but the present invention is not limited to this configuration. For example, in another embodiment, the accessing instruction may be transmitted to the transport vehicle 200 at the same time as the transmission of the excavation instruction to the work machine 100. In this case, the excavation and loading work can be performed more efficiently. Note that the transport vehicle 200 normally reaches the loading point P3 after the start of the hoist swing of the work machine 100 even when the accessing instruction is transmitted to the transport vehicle 200 the same time as the transmission of the excavation instruction to the work machine 100. In this case, the processes after step S16 are performed in the same manner as the first embodiment. On the other hand, in a case where the transport vehicle 200 reaches the loading point P3 before the start of the hoist swing of the work machine 100, the position of the dump body 201 may be specified as the target position of the hoist swing instruction in step S7.

In the above-described embodiment, the controlling gear 300 transmits the down swing instruction, the excavation instruction, and the hoist swing instruction separately to work machine 100, but the present invention is not limited to this configuration in another embodiment. For example, in another embodiment, the controlling gear 300 may transmit a comprehensive instruction of performing a series of the down swing work, the excavation work, and the hoist swing work, and the work machine 100 may execute the process of steps S2, S5, S8, and S9 based on the comprehensive instruction.

In the above-described embodiment, after the controlling gear 300 receives the completion notification of the hoist swing from the work machine 100, the controlling gear 300 transmits the accessing instruction to the transport vehicle 200, but the present invention is not limited to this configuration in another embodiment. For example, in another embodiment, the controlling gear 300 may transmit the accessing instruction to the transport vehicle 200 when a predetermined amount of time has passed since the hoist swing instruction or the above-described comprehensive instruction was transmitted to the work machine 100, or when the work machine 100 takes a predetermined posture.

In the above-described embodiment, the deviation adjustment control is performed by swinging the swing body 120, but the present invention is not limited to this configuration. For example, in a case where the transport vehicle 200 according to another embodiment can rotate the dump body 201 around the vertical axis, the deviation adjustment control may be performed by rotating the dump body 201 by the transport vehicle 200. In this case, the deviation adjustment unit 320 of the controlling gear 300 transmits the deviation adjustment instruction to the transport vehicle 200. In a case where the transport vehicle 200 can rotate the dump body 201, the turning of the transport vehicle 200 to move to the loading point P3 is not needed. Therefore, in this case, the approach route R3 may be a route connecting the standby point P1 and the loading point P3 or connecting the standby point P1 and the dumping point P4.

The work machine 100 according to the above-described embodiment performs the excavation and loading by automatic driving, but the present invention is not limited to this configuration. For example, the work machine 100 according to another embodiment may perform the excavation by a manual control of the operator, and execute the hoist swing, the dumping, and the down swing by automatic control. In this case, after the excavation is completed, the operator instructs the start of the automatic control by operating a button or the like provided on an operating device.

The controlling gear 300 according to the above-described embodiments may be formed of a single computer, or the configurations of the controlling gear 300 may be divided into a plurality of computers, and the plurality of computers may cooperate with each other to function as the controlling gear 300. At this time, some of configurations forming the controlling gear 300 may be realized by the control device 125 of the work machine 100 or the control device 220 of the transport vehicle 200. For example, in another embodiment, some of functions of the controlling gear 300 may be provided to the control device 125 of the work machine 100 and the control device 220 of the transport vehicle 200, and the work system may be configured by using inter-vehicle communication between the work machine 100 and the transport vehicle 200.

It is possible to prevent an excavation object held by a work machine from spilling when the excavation object is dumped in a transport vehicle.

1. A work system which controls a machine operating in a work site, the work system comprising:
a first control unit configured to output, to a work machine including work equipment, a first control signal of moving the work equipment to a position above a loading point before a transport vehicle including a dump body reaches the loading point;
a transmission unit configured to transmit, to the transport vehicle, an accessing instruction to travel the transport vehicle such that the dump body is located at the loading point; and
a second control unit configured to output a second control signal of controlling the work machine or the transport vehicle such that a deviation between a waiting position of the work equipment and a position of the dump body when the transport vehicle arrives at the loading point based on the accessing instruction becomes small, the waiting position being a position of the work equipment holding an excavation object and waiting based on the first control signal.

2. The work system according to claim 1, wherein
the second control unit outputs a signal of swinging the work machine or the transport vehicle such that the waiting position matches the position of the dump body.

3. The work system according to claim 1, wherein
the second control unit determines whether an angle formed by a line connecting a swing center of the work machine and a center of the work equipment and a line connecting the swing center of the work machine and a center of the dump body is within a predetermined angle range, and outputs the second control signal upon determining that the angle exceeds the angle range.

4. The work system according to claim 1, wherein
the second control unit determines whether a deviation amount between the waiting position and the position of the dump body is within a predetermined non-adjustment range when the work equipment holds the excavation object at the waiting position, and outputs the second control signal upon determining that the deviation amount exceeds the non-adjustment range.

5. A control method of controlling a machine operating in a work site, the control method comprising:
outputting, to a work machine including work equipment, a first control signal of moving the work equipment to a position above a loading point before a transport vehicle including a dump body reaches the loading point;
transmitting, to the transport vehicle, an accessing instruction to move the transport vehicle such that the dump body is located at the loading point; and
outputting a second control signal of controlling the work machine or the transport vehicle such that a deviation between a waiting position of the work equipment and a position of the dump body when the transport vehicle arrives at the loading point based on the accessing instruction becomes small, the waiting position being a position of the work equipment holding an excavation object and waiting based on the first control signal.

6. The work system according to claim 2, wherein
the second control unit determines whether an angle formed by a line connecting a swing center of the work machine and a center of the work equipment and a line connecting the swing center of the work machine and a center of the dump body is within a predetermined angle range, and outputs the second control signal upon determining that the angle exceeds the angle range.

7. The work system according to claim 6, wherein
the second control unit determines whether a deviation amount between the waiting position and the position of the dump body is within a predetermined non-adjustment range when the work equipment holds the excavation object at the waiting position, and outputs the second control signal upon determining that the deviation amount exceeds the non-adjustment range.

8. The work system according to claim 2, wherein
the second control unit determines whether a deviation amount between the waiting position and the position of the dump body is within a predetermined non-adjustment range when the work equipment holds the excavation object at the waiting position, and outputs the second control signal upon determining that the deviation amount exceeds the non-adjustment range.

9. The work system according to claim 3, wherein
the second control unit determines whether a deviation amount between the waiting position and the position of the dump body is within a predetermined non-adjustment range when the work equipment holds the excavation object at the waiting position, and outputs the second control signal upon determining that the deviation amount exceeds the non-adjustment range.
